(19) United States
(12) Patent Application Publication
(10) Pub. No.: US 2015/0325225 A1
(43) Pub. Date: Nov. 12, 2015

(54) METHOD FOR MUSICAL COMPOSITION, MUSICAL COMPOSITION PROGRAM PRODUCT AND MUSICAL COMPOSITION SYSTEM

(71) Applicant: VONTAGE CO., LTD., NEW TAIPEI (TW)

(72) Inventor: Hsi-Chun WANG, NEW TAIPEI (TW)

(21) Appl. No.: 14/586,147

(22) Filed: Dec. 30, 2014

(30) Foreign Application Priority Data
May 7, 2014 (TW) 103116286

(51) Int. Cl. G10H 1/40

(52) U.S. Cl. CPC G10H 1/40

(57) ABSTRACT

A musical composition method, a musical composition program product, and a musical composition system are disclosed in the invention. The composition method comprises two main steps: a pitch input step enables the user to enter pitch symbols that displayed on a display device; a beat input step that provides the user a prompt signal on each beat based on predetermined tempo enables the user to input action signals based on desired rhythm. The time points of action signals are assigned as the time points for the corresponding pitch symbols. After assigning their time points, the pitch symbols are regarded as completed notes and form a song. The composition program product can be executed on an electronic device, performing the steps of the aforesaid composition method. The composition system utilizes a pitch input interface and a beat input interface on an electronic device to provide musical composition functions.

### BACKGROUND OF THE INVENTION

1. Field of the Invention

The present invention relates to musical composition technology, specifically a method for musical composition, a musical composition program product, and a musical composition system used on an electronic device.

2. Description of the Related Art

WO 2006/019535A2 discloses a method of composing music on a handheld device. According to this method, a musical sequence is formed on the keypad of a handheld electronic device. The numbered keys on the keypad of the handheld device are mapped directly to corresponding notes in an octave. The sequence of the durations of musical notes is then entered by depressing at least one numbered key on the keypad and displaying a numerical representation of the sequence on the display screen of the handheld device. Although this technique allows musical composition on a handheld device, it requires the input of pitch and duration separately, one musical note at a time. The process is tedious, particular, and causes great inconvenience during operation.

So far, all known musical composition programs can assign pitch and duration to notes. However, most of the programs assign duration information using a keyboard or by inputting symbols. There are no musical composition programs that allow users to assign duration (beat) information to notes through motions, such as knocking or tapping of the hand or a tool.

### SUMMARY OF THE INVENTION

The first main objective of the present invention is to provide users a musical composition method, a musical composition program product, and a musical composition system, which allows the user to input note duration by knocking or tapping.

The second main objective of the present invention is to provide a musical composition method, a musical composition program product, and a musical composition system that is more convenient for composing music when compared to conventional techniques.

To achieve the above mentioned, the present invention introduces a specific method with two steps for musical composition. During the pitch input step, the pitch symbols are entered by the user, stored in memory, and shown on a display device in the order entered. Each pitch symbol is composed of its respective pitch information. During the beat input step, a prompt signal is given at the time point of each beat based on predetermined tempo (BPM-beats per minute). The prompt signals assist the user during the process of inputting action signals to record the desired rhythm. Each action signal is matched to a pitch symbol in terms of time point. The time points of the action signals are assigned as the time points for the corresponding pitch symbols. After assigning time points to the pitch symbols, they are regarded as completed notes and are shown on a display device and stored in the memory. In addition to pitch information, these completed notes also contain duration information from having time points.

The present invention provides a musical composition program product. It is installed in and executed by an electronic device. The pitch input step is performed by executing a pitch input program. The beat input step is performed by executing a beat input program. By executing these programs, the aforesaid musical composition method is accomplished.

Further, the present invention also provides a musical composition system. The system comprises an electronic device with a pitch input interface, a beat input interface, a memory, a display device, a speaker, and a processor. The memory contains a pitch input program, a player program, and a beat input program for execution by the processor. The pitch input program allows the user to input pitch symbols through the pitch input interface. The pitch symbols are shown on the display device with its respective pitch information. The player program has the ability to play the pitch symbols or musical notes through the speaker. The beat input program, based on predetermined tempo (BPM-beats per minute), provides the user a prompt signal at the time point of each beat. The prompt signals assist the user during the process of inputting action signals to record the desired rhythm. Each action signal is matched to a pitch symbol in terms of time point. The time points of the action signals are assigned as the time points for the corresponding pitch symbols. After assigning time points to the pitch symbols, they are regarded as completed notes and are shown on the display device. In addition to pitch information, these completed notes also contain duration information from having time points. The pitch symbols and the completed notes are stored in the memory.

Through the musical composition method, the musical composition program product, and the musical composition system mentioned above, the user can input duration (beat) information for each note by knocking or tapping, and thus, providing a more convenient way to compose than prior techniques.

### BRIEF DESCRIPTION OF THE DRAWINGS

The advantages and features of the present invention will be readily understood by reference to the following detailed description in conjunction with the accompanying drawings, in which like reference numerals identify identical elements and wherein:

FIG. 1 is a block diagram of a musical composition system in accordance with the first embodiment of the present invention.

FIG. 2 is an exploded view of an electronic device for the musical composition system in accordance with the first embodiment of the present invention.

FIG. 3 is a schematic drawing illustrating a pitch input interface for the musical composition system in accordance with the first embodiment of the present invention.

FIG. 4 is a schematic drawing illustrating a beat input interface for the musical composition system in accordance with the first embodiment of the present invention.

FIG. 5 is a flow chart of the method for musical composition accomplished by the musical composition system in accordance with the first embodiment of the present invention.

FIG. 6 is a rhythm schematic diagram of the first embodiment of the present invention illustrating the relationships among the shortest note durations, the action signals and the prompt signals.

FIG. 7 is an operation schematic diagram of the first embodiment of the present invention illustrating the time point determination of the first action signal.

FIG. 8 is an operation schematic diagram of the first embodiment of the present invention illustrating the time point determination of the second action signal.

FIG. 9 is an operation schematic diagram of the first embodiment of the present invention illustrating the time point determination of the third action signal.

FIG. 10 is a block diagram of a musical composition system in accordance with the second embodiment of the present invention.

FIG. 11 is a schematic drawing illustrating the appearance of the electronic device used in the musical composition system in accordance with the second embodiment of the present invention.

FIG. 12 is a block diagram of a musical composition system in accordance with the third embodiment of the present invention.

FIG. 13 is a schematic drawing of the third embodiment of the present invention illustrating the modifier buttons and the completed notes.

FIG. 14 is a flow chart of the method for musical composition accomplished by the musical composition system in accordance with the third embodiment of the present invention.

### DETAILED DESCRIPTION OF THE INVENTION

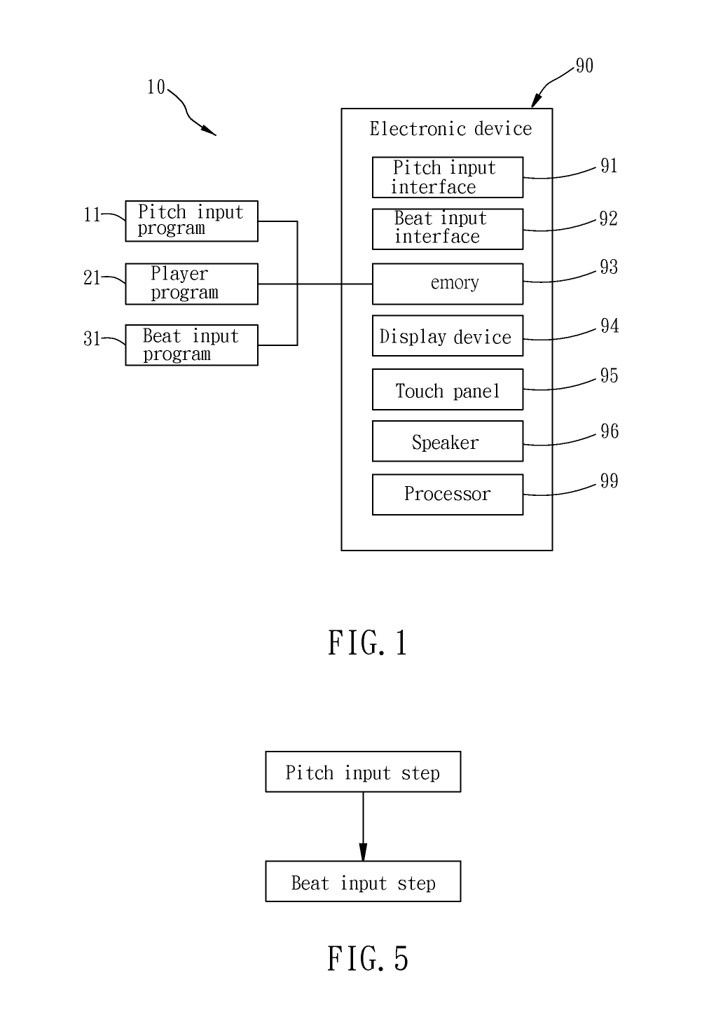

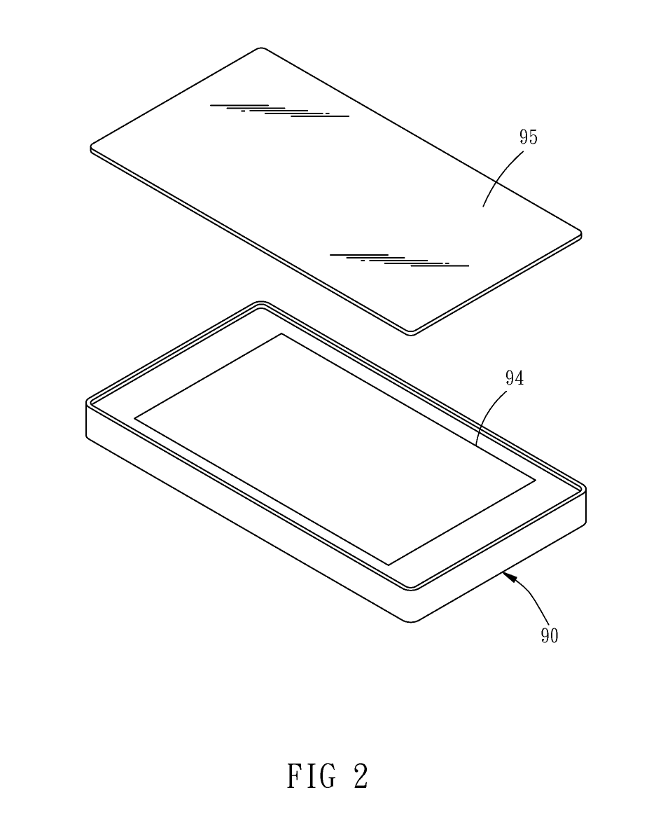

Referring to FIGS. 1-9, a musical composition system 10 in accordance with the first embodiment of the present invention is shown. The musical composition system 10 comprises an electronic device 90 with a pitch input interface 91, a beat input interface 92, a memory 93, a display device 94, a speaker 96 and a processor 99. The memory 93 contains a pitch input program 11, a player program 21 and a beat input program 31 for execution by the processor 99.

The electronic device 90 can be a personal computer, a tablet computer, a PDA or a smart phone. In this embodiment, the electronic device 90 is a smart phone. The electronic device 90 comprises a touch panel 95 located on the display device 94. The pitch input interface 91 is a set of icons displayed on the display device 94 beneath the touch panel 95 for tapping by the user to input data. The icons can be numbered keys or other symbol keys in appearance, or simply shown as graphic patterns. The input data can be numbers or other symbols to represent respective pitches. The beat input interface 92 is an icon displayed on the display device 94 beneath the touch panel 95 for tapping by the user to generate an action signal Sa. The icon can be shaped like a button, or simply shown as a graphic pattern. The pitch input interface 91 and the beat input interface 92 can be shown together on the screen of the display device 94. Alternatively, the pitch input interface 91 and the beat input interface 92 can be displayed separately, one at a time. In this embodiment, the pitch input interface 91 and the beat input interface 92 are displayed separately.

The pitch input program 11 allows the user to input pitch symbols M1 through the pitch input interface 91. The pitch symbols M1 are shown on the display device 94 with its respective pitch information. In this embodiment, when processor 99 executes the pitch input program 11, the pitch of each pitch symbol M1 is determined by the data entered through the pitch input interface 91.

The player program 21 has the ability to play the pitch symbols M1 or musical notes through the speaker 96.

The beat input program 31, based on predetermined tempo (BPM-beats per minute), provides the user a prompt signal Sh at the time point of each beat. The prompt signals Sh assist the user during the process of inputting action signals Sa through the beat input interface 92 to record the desired rhythm. Each action signal Sa is matched to a pitch symbol M1 in terms of time point. The time points of the action signals Sa are assigned as the time points for the corresponding pitch symbols M1. For each pitch symbol M1, its corresponding action signal's Sa time point is its duration start time as well as the previous pitch symbol's M1 duration end time. After assigning time points to each pitch symbol M1, it's regarded as a completed note N2. Then, it is shown on the display device 94. In addition to pitch information, these completed notes N2 also contain duration information from having time points. Simultaneously, when inputting action signals Sa, the electronic device 90 will use the player program 21 to play each action signal's Sa corresponding pitch symbol M1 with the preset sound (musical instrument, human vocal, or other sounds) through the speaker 96. Each time an action signal Sa is generated, the action signal's Sa corresponding pitch symbol M1 is played so the user can hear the sound. The prompt signal Sh is presented by sound or image through the electronic device 90. In this embodiment, sounds and images are both utilized. FIG. 4 shows an example of the prompt signal Sh image with the beat bar 921. The electronic device 90 controls the raising and lowering of the beat bar 921. When the beat bar 921 lowers, the displayed image changes from filled to blank gradually. When it raises, the displayed image changes from blank to filled gradually. The changing of the displayed image, raising and lowering the bar, is essentially the function of a metronome. The beat bar 921 can generate the prompt signal Sh at the time point where the bar is lowered down to blank. The beat bar 921 can also generate the prompt signal Sh at the time point where the bar is raised and becomes filled. These can be changed based on user preference. Manufacturers can set the electronic device 90 to play a sound through the speaker 96 when the prompt signals Sh are generated. The time points of the sounds played will be based on the manufacturers' preset time points of prompt signals Sh.

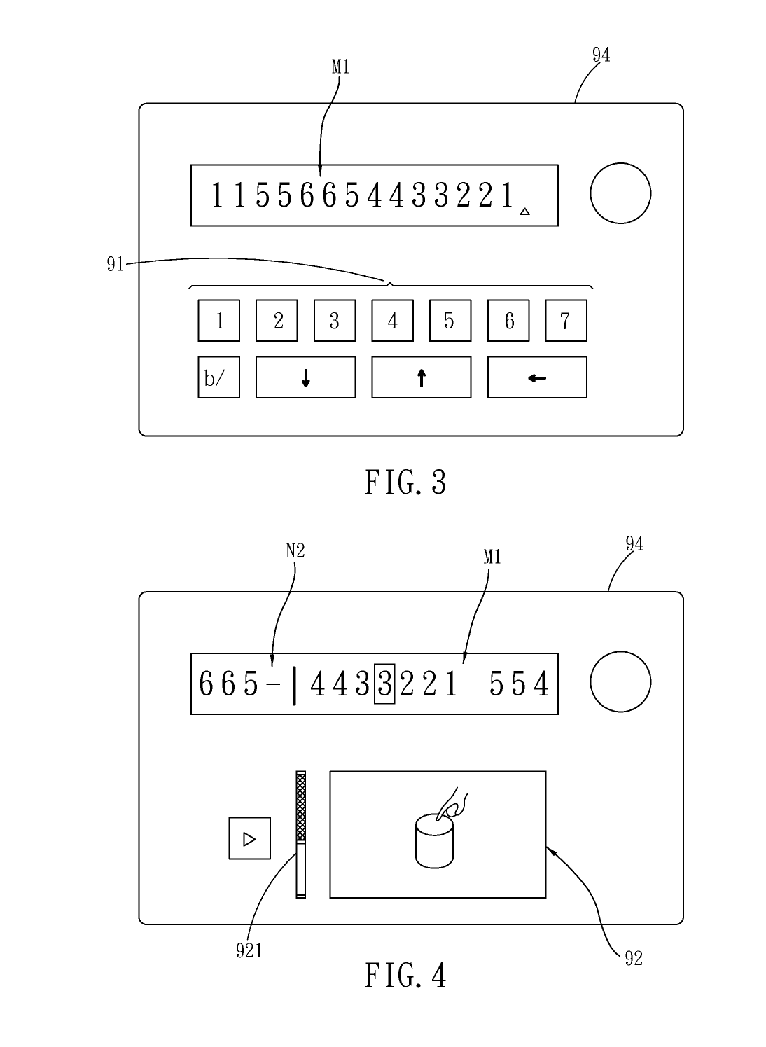

These pitch symbols M1 and the completed notes N2 are stored in the memory 93. Further, in this embodiment, pitch symbols M1 and/or completed notes N2 are shown on the display device 94 in the forms of numbered musical notation, five-line staff, six-line staff (tablature), combination of pitch symbols, or instrument specific staff. FIG. 3 and FIG. 4 are both in the form of numbered musical notation.

The aforesaid contains the explanation for the first embodiment's musical composition system 10 structure. The music composition method of the present invention will be used to explain the first embodiment's operation method.

Referring to FIG. 5, the method for musical composition comprises a pitch input step and a beat input step. During the pitch input step, the user uses the musical composition system 10 by driving the processor 99 to execute the pitch input program 11. The user can see the pitch input interface 91 on the display device 94 and use the pitch input interface 91 to input the desired pitch symbols M1 in a proper order. At this time, these pitch symbols M1 simply have pitch information without duration information, and the inputted pitch symbols M1 are displayed on the display device 94 and stored in the memory 93.

Next, proceeding with the beat input step, the user can change the screen on the display device 94 to show the interface 92 as shown in FIG. 4. At this time, the processor 99 executes the beat input program 31. Based on predetermined tempo, for example 60 beats per minute, a prompt signal Sh is given on each beat. The prompt signals Sh assist the user to input action signals Sa to record the desired rhythm through tapping on the beat input interface 92. Each action signal Sa is matched to a pitch symbol M1 in terms of time point. The time points of the action signals are assigned as the time points for the corresponding pitch symbols (this will be explained later). Simultaneously, the electronic device 90 plays each action signal's Sa corresponding pitch symbol M1 with the preset sound through the speaker 96 so the user can hear the sound. Thus, the user can assign duration information to each pitch symbol M1 based on the time interval of action signals Sa generated by the user's tapping actions. The pitch symbols M1 now containing both pitch information and duration information are regarded as completed notes N2. After assigning duration information to all pitch symbols M1, all the completed notes N2 are completed. The combination of these completed notes N2, stored in memory 93, forms a song and the composition work is accomplished. The user can use the electronic device 90 to play the song.

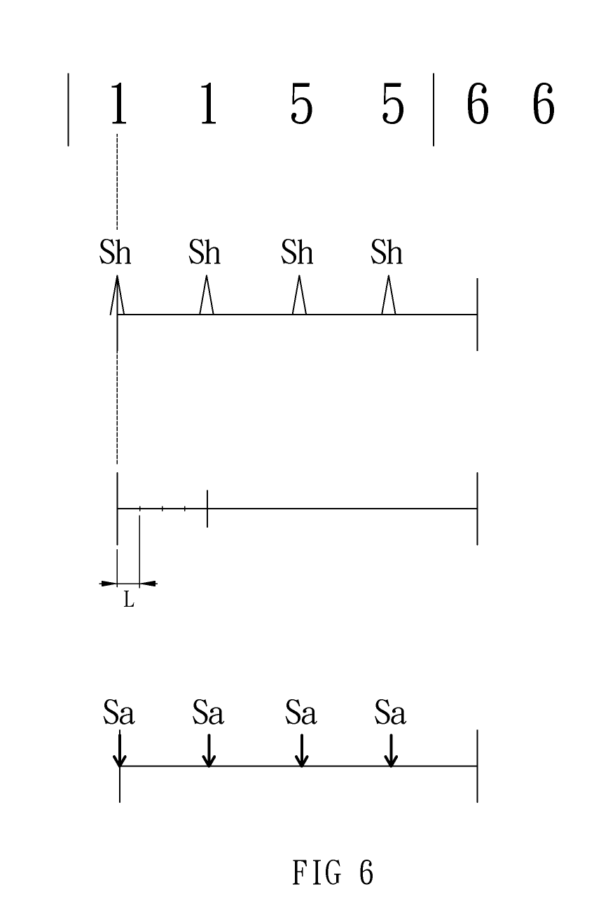

Referring to FIG. 6, during the process of inputting action signals Sa through tapping on the beat input interface 92, a shortest note duration L is defined by the beat input program 31. The time duration of the shortest note duration L can be changed based on user preference. This shortest note duration L is the shortest duration that can be entered, and is used as the smallest counting unit for durations. For example, if the shortest note duration L is a quarter of a beat (16^{th} note) in a time signature 4/4 bar, the beat input program 31 will generate a prompt signal Sh on every beat, generating a total of four prompt signals Sh in the bar. However, when determining the user's tapping time point, the time point closest to each quarter of a beat will be used. Thus, the durations assigned to the completed notes N2 will be accurate if the user taps at the correct time points.

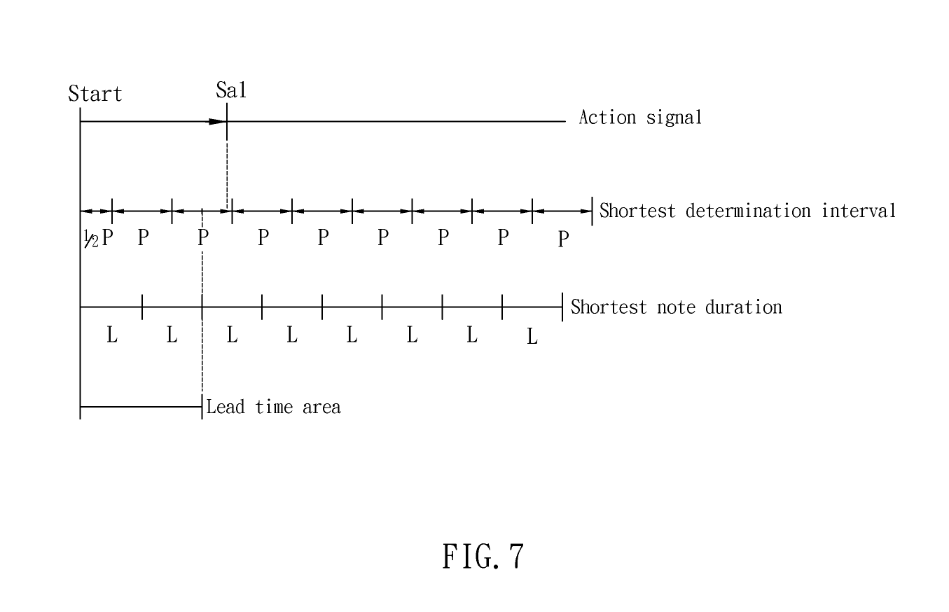

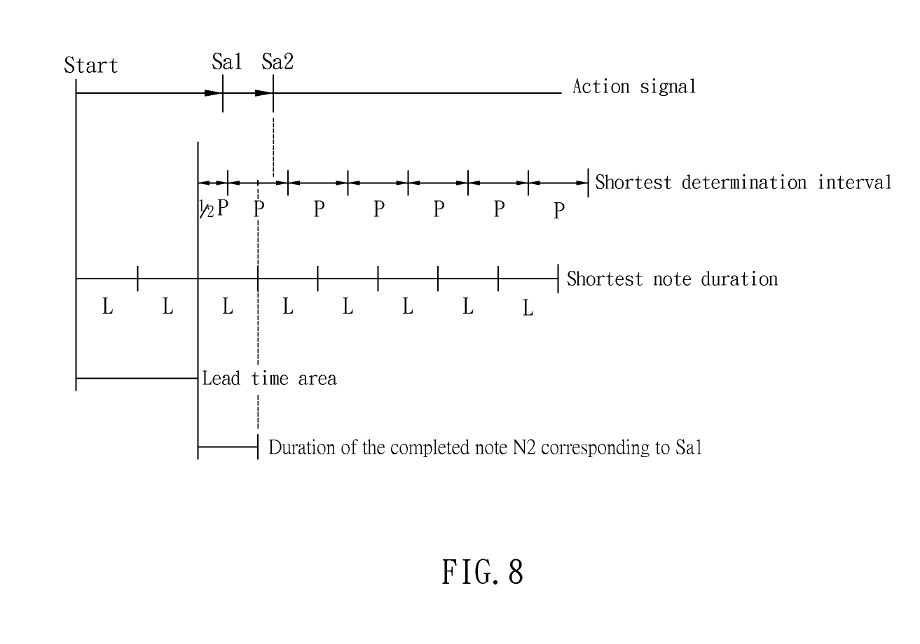

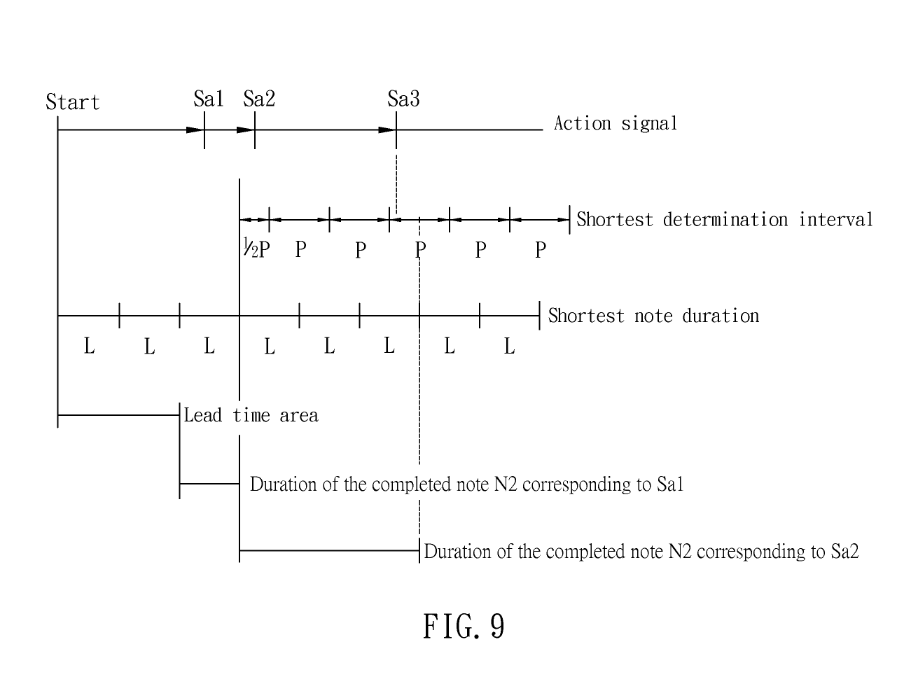

Also, as FIG. 7 through FIG. 9 indicates, an even more convenient method of interpretation can be used when determining the user's exact time of tapping. FIG. 7 illustrates how the time point of the action signal Sa1 is determined. FIG. 8, a continuance of FIG. 7, illustrates how the time point of the action signal Sat is determined. FIG. 9, a continuance of FIG. 8, illustrates how the time point of the action signal Sa3 is determined. Because the average person cannot carry out tapping actions as precise as a machine or a computer, a method of tap time determination which allows the user to tap with room for error is necessary. The determination will be carried out by the electronic device 90, increasing user convenience during input. In FIG. 7 through FIG. 9, other than the shortest note duration L, a shortest determination interval P was also defined by the beat input program 31. The time duration of the shortest determination interval P and the time duration of the shortest note duration L is the same. While the user inputs action signals Sa1˜Sa3, each of the action signals Sa1˜Sa3 will fall into one shortest determination interval P based on its corresponding time point. Each action signal's Sa1˜Sa3 corresponding shortest note duration L is determined through consecutive corresponding shortest determination intervals P and shortest note durations L. Specifically, each shortest determination interval P and each shortest note duration L are half phase apart, causing the midpoint of each shortest determination interval P to correspond to the end time point of each shortest note duration L. When there are two or more action signals present in one shortest determination interval P, only the first action signal will be used for determination. All others will be ignored. Therefore, when the time point corresponding to each of the action signals Sa1˜Sa3 falls within one shortest determination interval P, the time point corresponding to each of the action signals Sa1˜Sa3 is defined as the shortest note duration's L end time point corresponding to the midpoint of the shortest determination interval P. This allows the user to input action signals Sa without machine like precision, but will still allow the electronic device 90 to make the correct determination. As for the determination accuracy of the action signal's Sa time point, that can be changed through applying different time durations to the shortest note duration L and the shortest determination interval P.

Further explaining FIG. 7 through FIG. 9, starting action can be set through the beat input program 31. Meaning, the first tap on the beat input interface 92 can be set as the command to start. Next, as FIG. 7 shows, when the first action signal (Sa1) is generated, the initial half shortest determination interval (the shortest determination interval (½)P in Figure) is ignored. Meaning, if the corresponding time point of the first action signal (Sa1) falls within the initial half shortest determination interval, the action signal is ignored. In FIG. 7, the corresponding time point of the first action signal Sa1 falls within the second complete shortest determination interval P after the initial half shortest determination interval. Therefore, by determining the action signal Sa1 corresponding to the shortest determination interval P and the end time point of the shortest note duration L, the time point corresponding to the first action signal Sa1 can be determined and set as the first completed note's N2 duration start time. The area before that time point is the lead time area which no pitch symbol M1 would be present. As FIG. 8 shows, when the second action signal Sat is generated, if the time point falls within the same shortest determination interval P as the first action signal Sa1, the second action signal Sat will be ignored because that specific shortest determination interval P already has the first action signal Sa1 as its corresponding action signal. In FIG. 8, the second action signal Sat does not have a time point corresponding to the same shortest determination interval P as the first action signal Sa1, therefore it is a valid action signal. The end time point of the second action signal's Sat corresponding shortest note duration L was determined and set as the duration start time of the second completed note N2 as well as the duration end time of the first completed note N2. Thus, we know from FIG. 8 that the first completed note's N2 duration is one shortest note duration L. As FIG. 9 indicates, using the same rule, when the third action signal Sa3 is generated, the second completed note's N2 duration can be determined as three shortest note durations L. The following action signals can be determined using the same rule as well.

Based on the aforementioned, the last action signal Sa corresponds to the last completed note's N2 duration start time. At this time, a method must exist to give the last completed note N2 a duration end time. Here, the duration of the last completed note N2 can be determined by an extra action signal Sa generated by the user or by allowing the note to fill the remaining of the measure automatically with the processor 99.

According to the aforementioned explanations, through the musical composition system 10 and the method for musical composition in accordance with the first embodiment of the present invention, the user can input duration (beat) information for each note by knocking or tapping, and thus, providing a more convenient way to compose than prior techniques.

Furthermore, the aforementioned steps of the present invention's musical composition method can be used to create a musical composition program product. The program product is installed in and executed by the electronic device 90′. The pitch input step is performed by executing the pitch input program 11. The beat input step is performed by executing the beat input program 31. By executing these programs, the aforesaid musical composition method is accomplished.

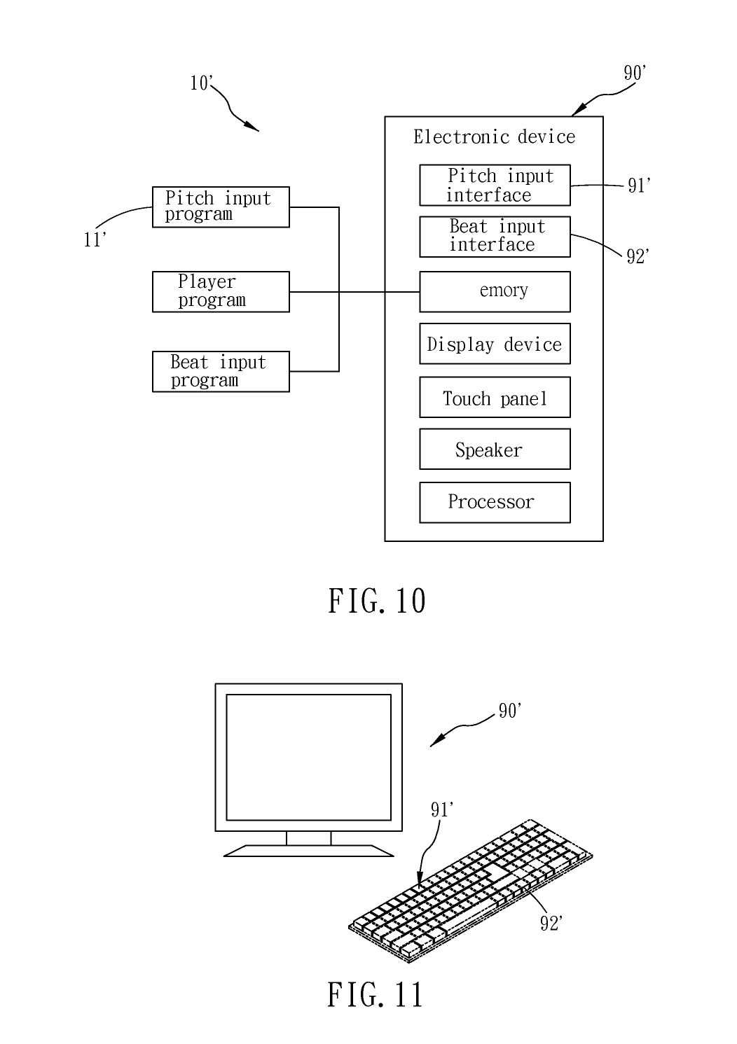

Referring to FIGS. 10 and 11, a musical composition system 10′ in accordance with the second embodiment of the present invention is shown. This second embodiment is substantially similar to the aforesaid first embodiment with some exceptions as follows:

The electronic device 90′ is a personal computer. The pitch input interface 91′ is a keyboard, not a touch panel. When the electronic device 90′ executes the pitch input program 11′, the pitch of each pitch symbol is determined by the data entered through the pitch input interface 91′. The beat input interface 92′ is a substantial beat key. An action signal (not shown, see FIG. 6) will be generated while the key is pressed.

The beat input interface 92′ in this second embodiment is not limited to be a key. Other input devices, such as an electronic drum or an optical sensor, could also be adopted to generate action signals.

Other structural details and features of this second embodiment are substantially the same as the aforesaid first embodiment, and thus will not be described further.

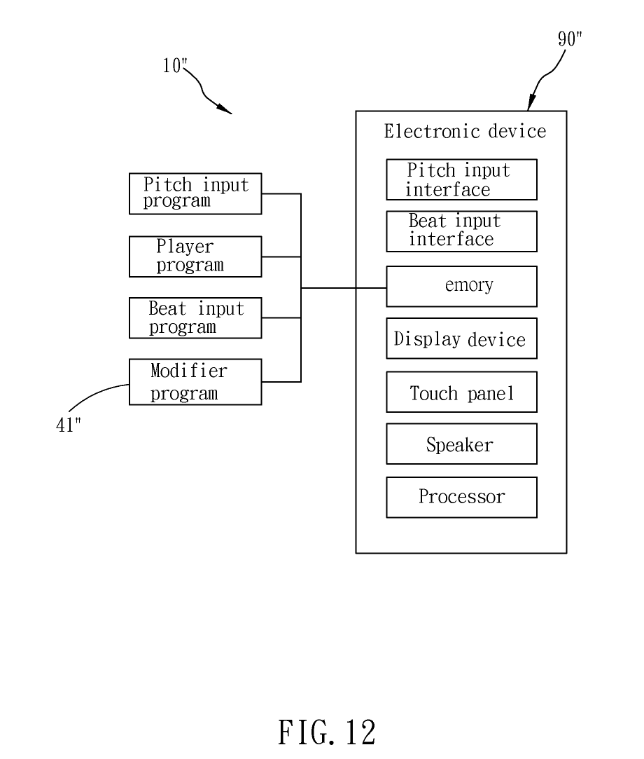

Referring to FIGS. 12-14, a musical composition system 10″ in accordance with the third embodiment of the present invention is shown. This third embodiment is substantially similar to the aforesaid first embodiment with some exception as follows:

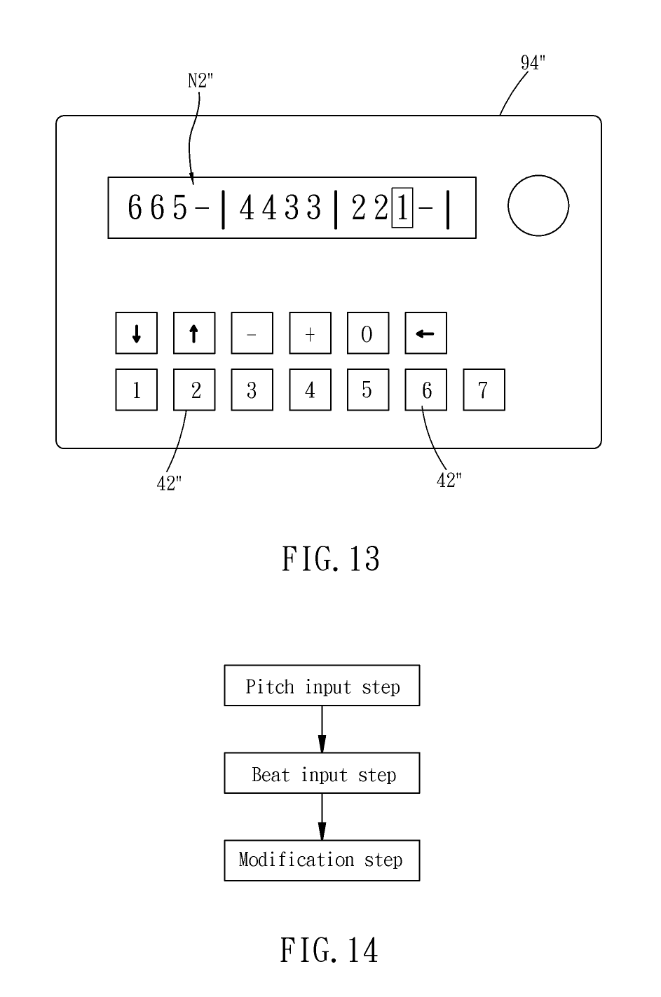

The musical composition system 10″ further contains a modifier program 41″. It is executed by the electronic device 90″, providing adjustment functions to apply changes to the pitch and duration of completed notes N2″. It also allows the input of ornament, rest, tone, octave, breath, expression, or dynamic indications for or between completed notes N2″ as well as time signature, chord, or tonality. In FIG. 13, the display device 94″ shows a plurality of modifier buttons 42″ corresponding to the functions described. When the user chooses one button, the corresponding function can be used.

As FIG. 14 shows, the musical composition method further includes a modification step in the third embodiment. The modification step is performed by executing the modifier program 41″ described above, thus providing the functions of inputting ornament, rest, tone, octave, breath, expression, or dynamic indications for and between completed notes N2″ as well as time signature, chord, or tonality.

During actual operation, modifications can be made by choosing the completed note N2″ to apply the modifications or by using the modifier buttons 42″ to complete any other functions. Through this, the music composed can be more emotional, invigorating, and complete. The modifier buttons 42″ are not limited to button forms. Other graphics can also be chosen and used based on user preference.

Other structure details and features of this third embodiment are substantially the same as the aforesaid first embodiment, and thus will not be described further.

Although particular embodiments of the invention are described in detail for purposes of illustration, various modifications and enhancements may be made without departing from the spirit and scope of the invention. Accordingly, the present invention is not to be limited except as by the appended claims.

What is claimed is:

1. A method for musical composition, comprising:
a pitch input step for users to enter a plurality of pitch symbols that stored in a memory and shown on a display device in a proper order, wherein each said pitch symbol is composed of its respective pitch information; and
a beat input step that providing a prompt signal at the time point of each beat based on predetermined tempo (BPM-beats per minute) to assist the user during the process of inputting a plurality of action signals to record the desired rhythm, wherein each said action signal is matched to a respective said pitch symbol in terms of time point; the time points of said action signals are assigned as the time points for the corresponding said pitch symbols; after assigning time points to said pitch symbols, they are regarded as completed notes and are shown on said display device and stored in said memory; in addition to pitch information, said completed notes also contain note duration information from having time points.

2. The method for musical composition of claim 1, wherein said beat input step defines a plurality of shortest note durations and a plurality of shortest determination intervals; one said shortest note duration is the shortest duration that can be entered; the time duration of each said shortest determination interval and the time duration of each said shortest note duration is the same; while the user inputs said action signals, each said action signal will fall into one said shortest determination interval based on its corresponding time point, each said action signal's corresponding shortest note duration is determined through consecutive corresponding said shortest determination intervals and said shortest note durations.

3. The method for musical composition of claim 2, wherein each said shortest determination interval and each said shortest note duration are half phase apart, causing the midpoint of each said shortest determination interval to correspond to the end time point of each said shortest note duration; when the time point corresponding to one said action signal falls within one said shortest determination interval, the time point corresponding to that action signal is defined as the shortest note duration's end time point corresponding to the midpoint of that shortest determination interval.

4. The method for musical composition of claim 1, wherein each said action signal's corresponding pitch symbol is played with a preset sound when inputting said action signals; said preset sound is musical instrument, human vocal, or other sounds; each said prompt signal is presented by sound and/or image.

5. The method for musical composition of claim 1, further comprising a modification step providing adjustment functions to apply changes to the pitch and duration of said completed notes.

6. A musical composition program product, the program product is installed in and executed by an electronic device, wherein a pitch input step is performed by executing a pitch input program and a beat input step is performed by executing a beat input program, by executing these said programs, the musical composition method of claim 1 is accomplished by said musical composition program product.

7. A musical composition system, comprising an electronic device with a pitch input interface, a beat input interface, a memory, a display device, and a processor; wherein said memory contains a pitch input program and a beat input program for execution by said processor, said pitch input program, through said pitch input interface, allows the user to input a plurality of pitch symbols that shown on said display device in a proper order, each said pitch symbol is composed of its respective pitch information; said beat input program, based on predetermined tempo (BPM-beats per minute), provides the user a prompt signal at the time point of each beat, said prompt signals assist the user during the process of inputting a plurality of action signals to record the desired rhythm, each said action signal is matched to a said pitch symbol in terms of time point, the time points of said action signals are assigned as the time points for the corresponding said pitch symbols; after assigning time points to said pitch symbols, they are regarded as completed notes and are shown on said display device; in addition to pitch information, said completed notes also contain duration information from having time points, said pitch symbols and said completed notes are stored in said memory.

8. The musical composition system of claim 7, wherein said beat input program defines a plurality of shortest note durations and a plurality of shortest determination intervals, one said shortest note duration is the shortest duration that can be entered; the time duration of each said shortest determination interval and the time duration of each said shortest note duration is the same; while the user inputs said action signals, each said action signal will fall into one said shortest determination interval based on its corresponding time point, each said action signal's corresponding shortest note duration is determined through consecutive corresponding said shortest determination intervals and said shortest note durations.

9. The musical composition system of claim 8, wherein each said shortest determination interval and each said shortest note duration are half phase apart, causing the midpoint of each said shortest determination interval to correspond to the end time point of each said shortest note duration; when the time point corresponding to one said action signal falls within one said shortest determination interval, the time point corresponding to that action signal is defined as the shortest note duration's end time point corresponding to the midpoint of that shortest determination interval.

10. The musical composition system of claim 7, wherein said pitch input interface of said electronic device is a keyboard; when said electronic device executes said pitch input program, the pitch of each said pitch symbol is determined by the data entered through said pitch input interface; said beat input interface of said electronic device is a substantial beat key, an said action signal will be generated while the key is pressed.

11. The musical composition system of claim 7, wherein said electronic device comprises a touch panel located on said display device; said pitch input interface is a set of a plurality of icons displayed on said display device beneath said touch panel for tapping by the user to input data; when said pitch input program is running, the pitch of each said pitch symbol is determined by the data entered through said pitch input interface; said beat input interface is an icon displayed on said display device beneath said touch panel for tapping by the user to generate said action signals.

12. The musical composition system of claim 7, further comprising a speaker, and wherein said memory contains a player program for execution by said processor; said player program has the ability to play said pitch symbols or musical notes through said speaker

13. The musical composition system of claim 12, wherein each said action signal's corresponding said pitch symbol is played with a preset sound through said speaker when the user inputs said action signals through said beat input interface based on desired rhythm; said preset sound is musical instrument, human vocal, or other sounds.

14. The musical composition system of claim 12, wherein each said prompt signal is presented by sound and/or image through said electronic device, where said sound is played through said speaker and said image is displayed on said display device.

15. The musical composition system of claim 7, further comprising a modification program, stored in said memory, for execution by said processor providing adjustment functions to apply changes to the pitch and duration of said completed notes.
